(19) United States
(12) Patent Application Publication
(10) Pub. No.: US 2026/0188248 A1
(43) Pub. Date: Jul. 2, 2026

(54) DISPLAY APPARATUS

(71) Applicant: LG DISPLAY CO., LTD., Seoul (KR)

(72) Inventor: Kyoungwon MIN, Goyang-si (KR)

(73) Assignee: LG DISPLAY CO., LTD., Seoul (KR)

(21) Appl. No.: 19/352,177

(22) Filed: Oct. 7, 2025

(30) Foreign Application Priority Data
Dec. 30, 2024 (KR) 10-2024-0200578

(51) Int. Cl. G09G 3/3266

(52) U.S. Cl. CPC G09G 3/3266; G09G 2310/08; G09G 2320/0673; G09G 2320/0686; G09G 2340/0407; G09G 2354/00

(57) ABSTRACT

Disclosed is a display apparatus configured to: select a gaze focus area as a scan driving start point, based on a focus position of a gaze and foveated rendering information, where the gaze focus area is an area on which the gaze of a user is being focused; and first supply a scan signal to the gaze focus area as the scan driving start point. This improves response characteristics and reduces latency.

### CROSS-REFERENCE TO RELATED APPLICATION

The present application claims the benefit of and priority to Korean Patent Application No. 10-2024-0200578, filed on Dec. 30, 2024, the entire contents of which are incorporated herein by reference for all purposes.

### BACKGROUND

### 1. Technical Field

The present disclosure relates to a display apparatus, and more particularly to, for example, without limitation, a display apparatus capable of immediately responding to a change in a gaze point of an eye.

### 2. Description of Related Art

Virtual reality (VR) refers to a specific environment and situation that feels similar to the real environment using stereoscopic image technology. A virtual reality device is being developed as a structure of various types of display apparatus such as a head mounted display (HMD), a face mounted display (FMD), an eye glass-type display (EGD), and the like.

Since the display apparatus for a virtual reality device performs graphic rendering in real time, a total latency for which image data from an image source is displayed as an image on a display panel varies in real time.

The description of related art should not be considered prior art merely because it is mentioned in or associated with this section. The description of related art includes information that describes one or more aspects of the subject technology, and the description in this section does not limit the scope of the invention.

### SUMMARY

A foveated rendering technique may be applied to a display apparatus. The foveated rendering technology is configured such that a full resolution is implemented in a gaze focus area in consideration of human cognitive characteristics, and a middle area and a peripheral area are implemented in a low resolution to reduce an amount of data to be rendered, thereby increasing the processing power of the graphics processing device, and reducing an amount of data transmission when displaying the virtual reality, thereby reducing latency due to data processing and transmission delay.

The graphics processing device of the virtual reality device detects a portion of an image in which the gaze focus area is located using eye tracking, renders the resolution such that the resolution in the gaze focus area is different from that in the area other than the gaze focus area and transmits the different resolutions per different areas. However, since the gaze focus area is not fixed on the actual panel, the actual panel cannot physically reduce the resolution and should express all resolutions.

The foveated rendering technology is applied to the display apparatus. In this regard, one horizontal line is sequentially driven over an entire screen area. However, since the display apparatus implements an image according to a predetermined frame rate, the display apparatus does not immediately respond to a change in the gaze point of the eye, and there is a disadvantage in that a delay occurs until a next frame is sequentially driven.

Accordingly, the inventor of the present disclosure has invented a display apparatus capable of immediately responding to a change in the gaze point of the eye and reducing the latency.

A technical aspect of the present disclosure is to provide a display apparatus capable of immediately responding to a change in gaze of an eye and reducing latency.

Aspects according to the present disclosure are not limited to the above-mentioned aspect. Other aspects and advantages according to the present disclosure that are not mentioned may be understood based on the present disclosure, and may be more clearly understood based on embodiments according to the present disclosure. Further, it will be easily understood that the aspects and advantages according to the present disclosure may be realized using means shown in the claims or combinations thereof.

A display apparatus according to an embodiment of the present disclosure is provided. The display apparatus may be configured to select a scan driving starting point as a gaze focus area on which a gaze is focused, and control a gate driver to first supply a scan signal to the gaze focus area.

According to an embodiment, the display apparatus may be configured to drive the gaze focus area at a full resolution, and drive a middle area at a medium resolution, and drive a peripheral area at a low resolution.

According to an embodiment, the display apparatus may be configured to sequentially drive the gaze focus area on a single scan line basis, and to drive each of the middle area and the peripheral area on a basis of at least two scan lines in a sequential and grouped manner.

According to an embodiment, the display apparatus may be configured to sequentially drive the gaze focus area on a single scan line basis in a vertically alternating manner, and to drive each of the middle area and the peripheral area on a basis of at least two scan lines in a sequential and grouped manner and in a vertically alternating manner.

According to an embodiment, the display apparatus may be configured to apply a data voltage to the gaze focus area on a single data line basis, and may be configured to drive each of the middle area and the peripheral area on a basis of at least two data lines in a grouped manner.

According to an embodiment, the display apparatus may be configured to maintain the luminance of the gaze focus area and control the luminance of each of the middle area and the peripheral area to be lower than that of the gaze focus area.

According to an embodiment of the present disclosure, the display apparatus may improve the response characteristic by selecting the gaze focus area as the scan driving start point.

In addition, the display apparatus displays the gaze focus area at the high quality or resolution and the other areas in the low quality or resolution, thereby reducing the latency.

In addition, the display apparatus may immediately respond to a change in the gaze point of the eye by selecting the gaze focus area as the scan driving start point.

In addition, the display apparatus may calculate the luminance gain value of each of the gaze focus area, the middle area, and the peripheral area and control the luminance of the gaze focus area, the middle area, and the peripheral area to be different from each other based on the calculation result, thereby reducing power consumption, and thus may be used for a longer time duration.

In addition, in response to the gaze point of the eye of the user being changed, the display apparatus may be configured to first perform the scan driving on the area where the gaze is focused, thereby improving the response characteristics and reducing the latency.

In addition, the display apparatus applies dynamic foveated rendering for tracking a gaze in real time to ensure stable performance of a graphics processing device of an external system.

In addition, the display apparatus may first drive the gaze focus area of the user's eye in response to the change in the gaze to improve response characteristics without delay due to sequential driving, and may control luminance of the different areas to be different from each other, thereby reducing power consumption.

Moreover, the display apparatus may first perform the scan driving of the gaze focus area, and may perform the scan driving in the alternating manner with each other in the vertical direction, thereby further improving the response characteristics and further lowering the latency.

Effects of the present disclosure are not limited to the effects mentioned above, and other effects not mentioned will be clearly understood by those skilled in the art from the description as set forth below.

In addition to the above effects, specific effects of the present disclosure are described together while describing specific details for carrying out the present disclosure.

Additional features, advantages, and aspects of the present disclosure are set forth in part in the description that follows and in part will become apparent from the present disclosure or may be learned by practice of the inventive concepts provided herein. Other features, advantages, and aspects of the present disclosure may be realized and attained by the descriptions provided in the present disclosure, or derivable therefrom, and the claims hereof as well as the drawings. It is intended that all such features, advantages, and aspects be included within this description, be within the scope of the present disclosure, and be protected by the following claims. Nothing in this section should be taken as a limitation on those claims. Further features, advantages, and aspects are discussed below in conjunction with embodiments of the present disclosure.

It is to be understood that both the foregoing description and the following description of the present disclosure are examples, and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure.

FIG. 1 is a block diagram illustrating a display apparatus according to an embodiment of the present disclosure.

FIG. 2 is a diagram illustrating sequential driving in a display apparatus according to an embodiment of the present disclosure.

FIG. 3 is a diagram illustrating a change in a gaze point of an eye on a display panel.

FIG. 4 is a diagram illustrating an operation method based on a change in a gaze point of an eye in a display apparatus according to an embodiment of the present disclosure.

FIG. 5 is a diagram illustrating different resolutions of different areas based on a gaze point of an eye in a display apparatus according to an embodiment of the present disclosure.

FIG. 6 to FIG. 11 is a diagram illustrating an operation method in response to a gaze point movement in a display apparatus according to an embodiment of the present disclosure.

FIGS. 12 and 13 are diagrams illustrating an operation method in response to a gaze point movement in a display apparatus according to another embodiment of the present disclosure.

FIG. 14 is a circuit diagram illustrating a gate driver in a display apparatus according to an embodiment of the present disclosure.

FIG. 15 is a diagram illustrating an operation timing of the gate driver of FIG. 14.

FIG. 16 is a diagram illustrating data processing based on a gaze point of an eye in a display apparatus according to an embodiment of the present disclosure.

FIG. 17 is a block diagram illustrating a controller of a display apparatus according to an embodiment of the present disclosure.

FIG. 18 is a flowchart illustrating a method for controlling a display apparatus according to an embodiment.

Throughout the drawings and the detailed description, unless otherwise described, the same drawing reference numerals should be understood to refer to the same elements, features, and structures. The sizes, lengths, and thicknesses of layers, regions and elements, and depiction thereof may be exaggerated for clarity, illustration, and/or convenience.

### DETAILED DESCRIPTION

Advantages and features of the present disclosure, and a method of achieving the advantages and features will become apparent with reference to embodiments described later in detail together with the accompanying drawings. However, the present disclosure is not limited to the embodiments as disclosed under, but may be implemented in various different forms. Thus, these embodiments are set forth only to make the present disclosure complete, and to completely inform the scope of the present disclosure to those of ordinary skill in the technical field to which the present disclosure belongs, and the present disclosure is only defined by the scope of the claims.

For simplicity and clarity of illustration, elements in the drawings are not necessarily drawn to scale. The same reference numbers in different drawings represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure. Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

A shape, a size, a ratio, an angle, a number, etc. disclosed in the drawings for illustrating embodiments of the present disclosure are illustrative, and the present disclosure is not limited thereto. The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise. For example, an element may be one or more elements unless the context clearly indicates otherwise. An element may include a plurality of elements unless the context clearly indicates otherwise. It will be further understood that the terms “comprise”, “comprising”, “include”, and “including” when used in this disclosure, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of associated listed items. Expression such as “at least one of” when preceding a list of elements may modify the entire list of elements and may not modify the individual elements of the list. In interpretation of numerical values, an error or tolerance therein may occur even when there is no explicit description thereof.

In descriptions of temporal relationships, for example, temporal precedent relationships between two events such as “after”, “subsequent to”, “before”, etc., another event may occur therebetween unless “directly after”, “directly subsequent” or “directly before” is not indicated. When a certain embodiment may be implemented differently, a function or an operation specified in a specific block may occur in a different order from an order specified in a flowchart. For example, two blocks in succession may be actually performed substantially concurrently, or the two blocks may be performed in a reverse order depending on a function or operation involved.

It will be understood that, although the terms “first”, “second”, “third”, and so on may be used herein to describe various elements, components, areas, layers and/or periods, these elements, components, areas, layers and/or periods should not be limited by these terms. These terms are used to distinguish one element, component, area, layer or section from another element, component, area, layer or period. Thus, a first element, component, area, layer or section as described under could be termed a second element, component, area, layer or period, without departing from the spirit and scope of the present disclosure.

When an embodiment may be implemented differently, functions or operations specified within a specific block may be performed in a different order from an order specified in a flowchart. For example, two consecutive blocks may actually be performed substantially simultaneously, or the blocks may be performed in a reverse order depending on related functions or operations. The features of the various embodiments of the present disclosure may be partially or entirely combined with each other, and may be technically associated with each other or operate with each other. The embodiments may be implemented independently of each other and may be implemented together in an association relationship.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terms used herein have been selected as being general in the related technical field; however, there may be other terms depending on the development and/or change of technology, convention, preference of technicians, and so on. Therefore, the terms used herein should not be understood as limiting technical ideas, but should be understood as examples of the terms for describing example embodiments.

Further, in a specific case, a term may be arbitrarily selected by an applicant, and in this case, the detailed meaning thereof is described herein. Therefore, the terms used herein should be understood based on not only the name of the terms, but also the meaning of the terms and the content hereof.

Unless stated otherwise, like reference numerals may refer to like elements throughout even when they are shown in different drawings. Unless stated otherwise, the same reference numerals may be used to refer to the same or substantially the same elements throughout the specification and the drawings. In one or more aspects, identical elements (or elements with identical names) in different drawings may have the same or substantially the same functions and properties unless stated otherwise. Names of the respective elements used in the following explanations are selected only for convenience and may be thus different from those used in actual products.

The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

In one or more aspects, unless explicitly stated otherwise, an element, feature, or corresponding information (e.g., a level, range, dimension, size, or the like) is construed to include an error or tolerance range even where no explicit description of such an error or tolerance range is provided. An error or tolerance range may be caused by various factors (e.g., process factors, internal or external impact, noise, or the like). In interpreting a numerical value, the value is interpreted as including an error range unless explicitly stated otherwise.

When a positional relationship between two elements (e.g., layers, components, electrodes, structures, transistors, sections, members, parts, regions, areas, portions, and/or the like) are described using any of the terms such as “on,” “over,” “under,” “above,” “below,” “near,” “close to,” “adjacent to,” “beside,” “next to,” “at or on a side of,” and/or the like indicating a position or location, one or more other elements may be located between the two elements unless a more limiting term, such as “immediate(ly),” “direct(ly),” or “close(ly),” is used. For example, when an element and another element are described using any of the foregoing terms, this description should be construed as including a case in which the elements contact each other directly as well as a case in which one or more additional elements are disposed or interposed therebetween.

The expression that an element (e.g., layer, component, electrode, structure, transistor, section, member, part, region, area, portion, or the like) “is engaged” with another element may be understood, for example, as that the element may be either directly or indirectly engaged with the another element. The term “is engaged” or similar expressions may refer to a term such as “is in contact,” “overlaps,” “crosses,” “intersects,” “is connected,” “is coupled,” “is attached,” “is adhered,” “is combined,” “is linked,” “is provided,” “is disposed,” “interacts,” or the like. The engagement may involve one or more intervening elements disposed or interposed between the element and the another element, unless otherwise specified. Further, the element may be engaged at least partially or entirely (or completely) with the another element, unless otherwise specified. Further, the element may be included in at least one of two or more elements that are engaged with each other. Similarly, the another element may be included in at least one of two or more elements that are engaged with each other. When the element is engaged with the another element, at least a portion of the element may be engaged with at least a portion of the another element. The term “with another element” or similar expressions may be understood as “another element,” or “with, to, in, or on another element,” as appropriate by the context. Similarly, the term “with each other” may be understood as “each other,” or “with, to, or on each other,” as appropriate by the context.

The terms such as a “line” or “direction” should not be interpreted only based on a geometrical relationship in which the respective lines or directions are parallel, perpendicular, diagonal, or slanted with respect to each other, and may be meant as lines or directions having wider directivities within the range within which the components of the present disclosure may operate functionally.

The term “at least one” should be understood as including any and all combinations of one or more of the associated listed items. For example, each of the phrases “at least one of a first item, a second item, or a third item” and “at least one of a first item, a second item, and a third item” may represent (i) a combination of items provided by two or more of the first item, the second item, and the third item or (ii) only one of the first item, the second item, or the third item. Further, at least one of a plurality of elements can represent (i) one element of the plurality of elements, (ii) some elements of the plurality of elements, or (iii) all elements of the plurality of elements. Further, “at least some,” “at least some portions,” “at least some parts,” “at least a portion,” “at least one or more portions,” “at least a part,” “at least one or more parts,” “at least some elements,” “one or more,” or the like of a plurality of elements can represent (i) one element of the plurality of elements, (ii) a portion (or a part) of the plurality of elements, (iii) one or more portions (or parts) of the plurality of elements, (iv) multiple elements of the plurality of elements, or (v) all of the plurality of elements. Moreover, “at least some,” “at least some portions,” “at least some parts,” “at least a portion,” “at least one or more portions,” “at least a part,” “at least one or more parts,” or the like of an element can represent (i) a portion (or a part) of the element, (ii) one or more portions (or parts) of the element, (iii) the element, or (iv) all portions of the element.

In one or more aspects, the terms “between” and “among” may be used interchangeably simply for convenience unless stated otherwise. For example, an expression “between a plurality of elements” may be understood as among a plurality of elements. In another example, an expression “among a plurality of elements” may be understood as between a plurality of elements. In one or more examples, the number of elements may be two. In one or more examples, the number of elements may be more than two. Furthermore, when an element is referred to as being “between” at least two elements, the element may be the only element between the at least two elements, or one or more intervening elements may also be present.

In one or more aspects, the phrases “each other” and “one another” may be used interchangeably simply for convenience unless stated otherwise. For example, an expression “different from each other” may be understood as being different from one another. In another example, an expression “different from one another” may be understood as being different from each other. In one or more examples, the number of elements involved in the foregoing expression may be two. In one or more examples, the number of elements involved in the foregoing expression may be more than two.

In one or more aspects, the phrases “one or more among” and “one or more of” may be used interchangeably simply for convenience unless stated otherwise.

A phrase “substantially the same” or “nearly the same” may indicate a degree of being considered as being equivalent to each other taking into account minute differences due to errors in the manufacturing process.

In the following description, various example embodiments of the present disclosure are described in more detail with reference to the accompanying drawings. With respect to reference numerals to elements of each of the drawings, the same or similar elements may be illustrated in other drawings, and like reference numerals may refer to like or similar elements unless stated otherwise. The same or similar elements may be denoted by the same reference numerals even if they are depicted in different drawings. Repetitive descriptions of the same or similar elements may be omitted for brevity, and the descriptions provided for elements in one or more figures may also apply to elements in other figures that use the same or similar reference numerals unless stated otherwise. In addition, for the convenience of description, a scale, dimension, size, and thickness of each of the elements illustrated in the accompanying drawings may be different from an actual scale, dimension, size, and thickness, and thus, embodiments of the present disclosure are not limited to a scale, dimension, size, and thickness illustrated in the drawings.

In description of flow of a signal, for example, when a signal is delivered from a node A to a node B, this may include a case where the signal is transferred from the node A to the node B via another node unless a phrase “immediately transferred” or “directly transferred” is used. Throughout the present disclosure, “A and/or B” means A, B, or A and B, unless otherwise specified, and “C to D” means C inclusive to D inclusive unless otherwise specified. In interpreting a numerical value, the value is interpreted as including an error range unless there is no separate explicit description thereof. Further, the term “or” means “inclusive or” rather than “exclusive or”. That is, unless otherwise stated or clear from the context, the expression that “x uses a or b” means one of natural inclusive permutations. For example, “a or b” may mean “a,” “b,” or “a and b.” For example, “a, b or c” may mean “a,” “b,” “c,” “a and b,” “b and c,” “a and c,” or “a, b and c.”

Hereinafter, a display apparatus capable of immediately responding to a change in the gaze point of the eye and capable of reducing the latency will be described in detail. Hereinafter, various embodiments of the present disclosure will be described in detail with reference to the accompanying drawings.

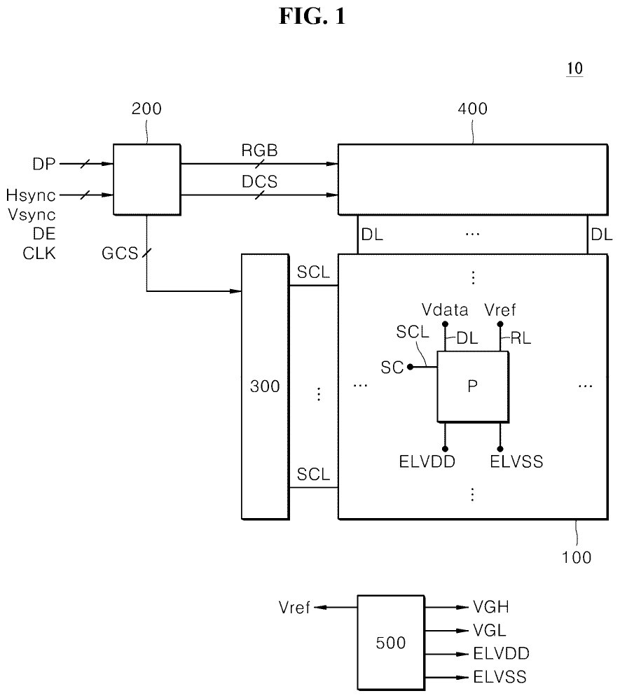

FIG. 1 is a block diagram illustrating a display apparatus according to an embodiment of the present disclosure.

Referring to FIG. 1, a display apparatus 10 includes a display panel 100 including a plurality of pixels P, a controller 200, a gate driver 300 configured to supply scan signals SC to the plurality of pixels P, a data driver 400 configured to supply data voltages Vdata to the plurality of pixels P, and a power supply 500 configured to supply voltages necessary for driving the plurality of pixels P.

In the display panel 100, a plurality of scan lines SCL and a plurality of data lines DL intersect each other, and each of the plurality of pixels P is connected to the scan line SCL and the data line DL. Specifically, one pixel P receives the scan signal SC through the scan line SCL, receives the data voltage Vdata through the data line DL, and receives a reference voltage Vref, a high potential driving voltage ELVDD, and a low potential driving voltage ELVSS from the power supply 500.

The scan line SCL supplies the scan signal SC and a sensing signal to the pixel P, and the data line DL supplies the data voltage Vdata to the pixel P. In addition, according to various embodiments, the scan line SCL, and a sensing line supplying the sensing signal may be individually connected to the pixel P.

In addition, the display panel 100 further includes a power line. The plurality of pixels P may receive the high-potential driving voltage ELVDD and the low-potential driving voltage ELVSS via the power line. In addition, the display panel 100 further includes a reference voltage line RL. The plurality of pixels P may receive the reference voltage Vref via the reference voltage line RL.

In addition, each of the pixels P includes a light-emitting element LD and a pixel circuit PC for driving the light-emitting element LD. The pixel circuit includes a plurality of switching elements, a driving element, and a capacitor. In this regard, each of the switching element and the driving element may include a thin-film transistor. In the pixel circuit, the driving element controls an amount of current supplied to the light-emitting element based on the data voltage to adjust an amount of light emitted from the light-emitting element. In addition, the switching element transmits the data voltage Vdata and the reference voltage Vref to the driving element and the capacitor in response to the scan signal SC.

The display panel 100 may be implemented as a non-transmissive display panel or a transmissive display panel. The transmissive display panel may be applied to a transparent display apparatus in which an image is displayed on a screen and a real object in the background is visible to a viewer in front of the display apparatus. The display panel 100 may be manufactured as a flexible display panel. The flexible display panel may be implemented as an OLED panel using a plastic substrate.

The pixels P may include red, green, and blue pixels for color realization. The pixels P may further include a white pixel.

Touch sensors TS may be disposed on the display panel 100. The touch input may be sensed using separate touch sensors or may be sensed through the pixels P. The touch sensors may be disposed on the screen of the display panel in an on-cell type or an add-on type or be embodied as in-cell type touch sensors embedded in the display panel 100.

The controller 200 receives image information DP from a host system, processes image data RGB included in the image information DP so as to be suitable for a size and a resolution of the display panel 100, and supplies the processed image data RGB to the data driver 400. The controller 200 generates a gate control signal GCS and a data control signal DCS using synchronization signals input from an external source, for example, a clock signal CLK, a data enable signal DE, a horizontal synchronization signal Hsync, and a vertical synchronization signal Vsync. The gate control signal GCS and the data control signal DCS are supplied to the gate driver 300 and the data driver 400, respectively, to control the gate driver 300 and the data driver 400.

A voltage level of the gate control signal GCS output from the controller 200 may be converted into a gate-on voltage and a gate-off voltage via a level shifter and then may be supplied to the gate driver 300. The level shifter converts a low level voltage of the gate control signal GCS into a gate low voltage VGL, and converts a high level voltage of the gate control signal GCS into a gate high voltage VGH. The gate control signal GCS includes a start pulse and a shift clock.

The gate driver 300 supplies the scan signal SC to the scan line SCL according to the gate control signal GCS. The gate driver 300 may be disposed on one side or each of both opposing sides of the display panel 100 in a gate in panel (GIP) manner.

The gate driver 300 outputs a scan pulse in response to a start pulse and a shift clock from the controller 200, and sequentially shifts the scan pulse according to the shift clock.

The data driver 400 converts the image data RGB into the data voltage Vdata according to the data control signal DCS, and supplies the converted data voltage Vdata to the pixel P through the data line DL.

Although FIG. 1 illustrates that one data driver 400 is disposed on one side of the display panel 100, the number and arrangement position of the data driver 400 are not limited thereto. That is, the data driver 400 may be embodied as a plurality of integrated circuits (ICs) which may be disposed on one side of the display panel 100 and may be separately arranged.

The power supply 500 generates DC power required for driving the pixel array of the display panel 100, the gate driver 300, and the data driver 400. The power supply 500 may include a charge pump, a regulator, a buck converter, a boost converter, etc.

The power supply 500 may receive an input voltage from the host system and may generate a DC voltage such as the gate high voltage VGH, the gate low voltage VGL, the high potential driving voltage ELVDD, the low potential driving voltage ELVSS, and the reference voltage Vref. The gate low voltage VGL and the gate high voltage VGH may be supplied to the gate driver 300, and the high potential driving voltage ELVDD, the low potential driving voltage ELVSS, and the reference voltage Vref may be supplied to the pixels P.

The host system may be a graphics processing device of a virtual reality device. The image information DP received from the host system may include real-time eye tracking information.

The controller 200 may divide an area of the display panel into a gaze focus area, a middle area, and a peripheral area based on the real-time eye tracking information. As used herein, the gaze focus area Z may be defined as a predetermined area on which the gaze of the eye of the user is focused, the middle area Y may be defined as an area located outwardly and around the gaze focus area Z, and the peripheral area X may be defined as an area located outwardly and around the middle area Y.

The controller 200 may be configured to drive the gaze focus area Z of the display panel 100 at a full resolution, drive the middle area Y of the display panel 100 at a medium resolution, and drive the peripheral area X of the display panel 100 at low resolution. In addition, the controller 200 may control the luminance of the gaze focus area, the middle area, and the peripheral area of the display panel to be different from each other.

In the present disclosure, a display apparatus to which the foveated rendering (FR) technique may be applied is disclosed. In an aspect, the foveated rendering technology may include technology capable of increasing the processing capability of the graphics processing device by driving the gaze focus area of the eye of the user at a full resolution (or a high resolution) in consideration of human cognitive characteristics, and driving the middle area and the peripheral area at a low resolution to reduce the amount of data to be rendered, and reducing the amount of data transmission in implementing the virtual reality to reduce the latency due to data processing and transmission delay.

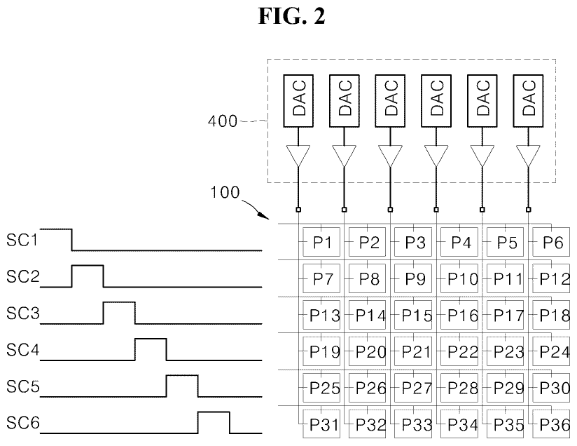

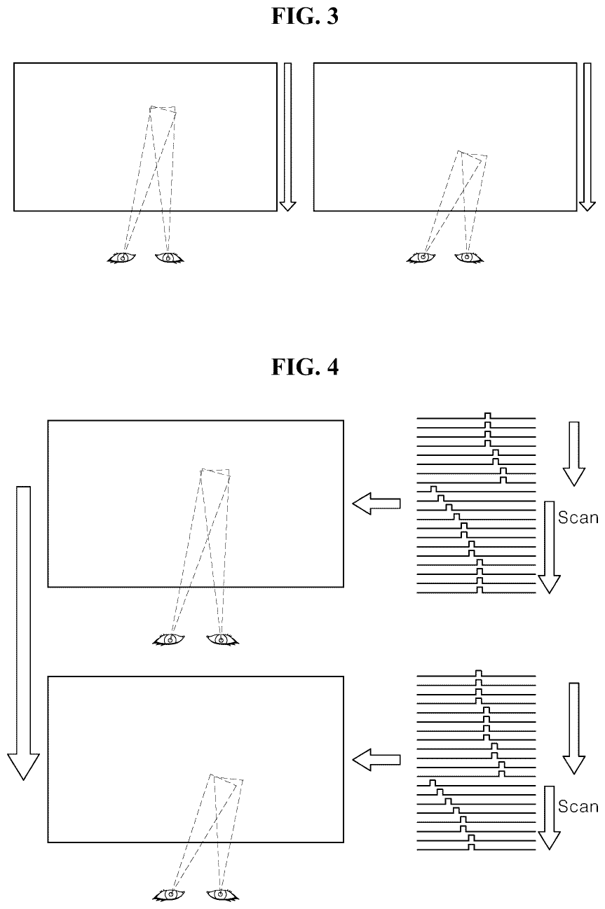

FIG. 2 is a diagram illustrating sequential driving in a display apparatus according to an embodiment of the present disclosure. FIG. 3 is a diagram illustrating a change in a gaze point of an eye on a display panel.

Referring to FIGS. 2 and 3, the display apparatus 10 has a structure in which in response to the gaze point of the eye being changed, scan signals SC1 to SC6 are sequentially applied to all areas of the display panel 100 such that the data voltage is applied thereto on a single scan line basis.

A DAC of the data driver 400 represents a digital-to-analog converter that converts image data to a data voltage as an analog signal. In addition, the data driver 400 may further include an output buffer that outputs the data voltage converted by the DAC to the display panel 100.

In the sequential driving of the display panel, the image is implemented according to a predetermined frame rate. Thus, this scheme cannot immediately respond to the change in the gaze point, and a delay occurs until a next frame is sequentially driven, thereby increasing the latency. That is, in the sequential driving, even when the foveated rendering information from the graphics processing device of an external system is received by the display apparatus, the display apparatus may not immediately respond to the change in the gaze point based on the foveated rendering information.

Accordingly, there is a demand for an operation method capable of improving latency based on the change in the eye gaze point.

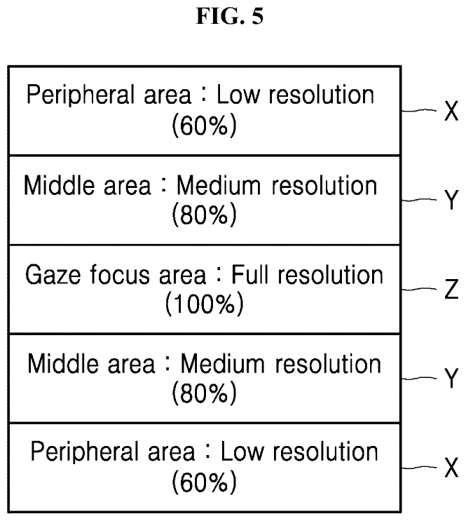

FIG. 4 is a diagram illustrating an operation method based on a change in a gaze point of an eye in a display apparatus according to an embodiment of the present disclosure. FIG. 5 is a diagram illustrating different resolutions of different areas based on a gaze point of an eye in a display apparatus according to an embodiment of the present disclosure.

The display apparatus according to an embodiment of the present disclosure is configured to identify an area of a display panel on which the gaze of the eye is focused based on the foveated rendering information received from the external system and a focus position of the gaze, and to define the area of the display panel on which the gaze is focused as the gaze focus area, and to first drive the gaze focus area, thereby reducing the latency.

Referring to FIGS. 4 and 5, the display apparatus 10 first applies a scan signal to the gaze focus area on which the gaze is focused. For example, in response to the gaze point of the eye of the user being the center of the display panel, the display apparatus sequentially first applies the scan signal to a center of the display panel. In addition, in response to the gaze point of the eye of the user being changed from the center to a bottom of the display panel, the display apparatus first applies the scan signal to the bottom thereof.

In addition, based on the foveated rendering information, the display apparatus 10 may be configured to drive the gaze focus area Z at a full resolution of 100%, drive the middle area Y at a medium resolution of 80%, and drive the peripheral area X at a low resolution of 60%.

In order to implement this scheme, the display apparatus 10 may be configured to apply a scan signal to the gaze focus area Z on a single scan line basis, to apply a scan signal to the middle area Y on a basis of at least two scan lines, and to apply a scan signal to the peripheral area X on a basis of at least four scan lines. In addition, the display apparatus 10 may be configured to apply a data voltage to the gaze focus area Z on a single pixel basis (e.g., each relevant pixel receives its own data voltage), apply a data voltage to the middle area Y on a basis of at least two pixels (e.g., two relevant pixels receive a data voltage that is the same), and apply a data voltage to the peripheral area X on a basis of at least four pixels (e.g., four relevant pixels receive another data voltage that is the same).

In addition, the display apparatus may control luminance of the gaze focus area Z, the middle area Y, and the peripheral area X to be different from each other. For example, the display apparatus may control the luminance to be lowered step by step in the order of the gaze focus area Z, the middle area Y, and the peripheral area X. That is, the display apparatus may control the luminance of the gaze focus area Z to be the highest, the luminance of the middle area Y to the middle, and luminance of the peripheral area X to be the lowest. To this end, gamma reference voltages respectively applied to the data driver 400 for the gaze focus area Z, the middle area Y, and the peripheral area X may be set to be different from each other, thereby controlling the luminance of the different areas to be different from each other.

A method for operating a display apparatus capable of reducing the latency based on the change in the gaze point will be described in more detail as follows.

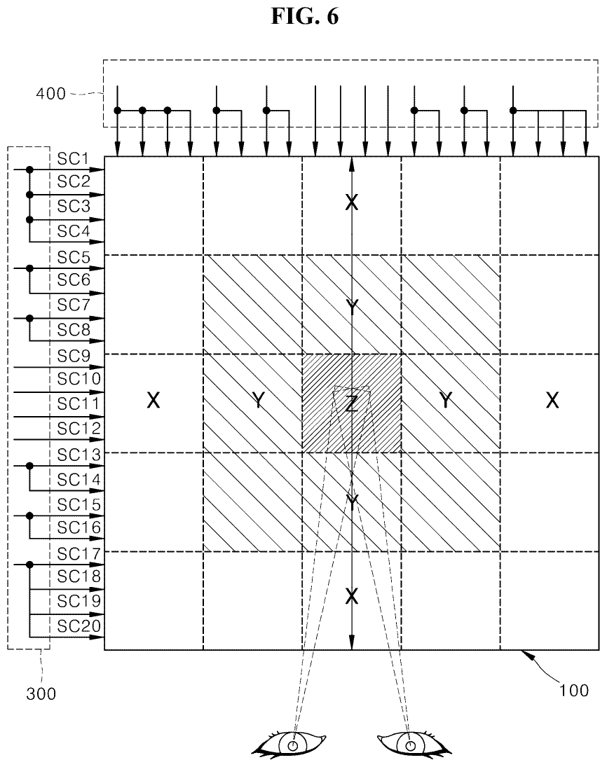

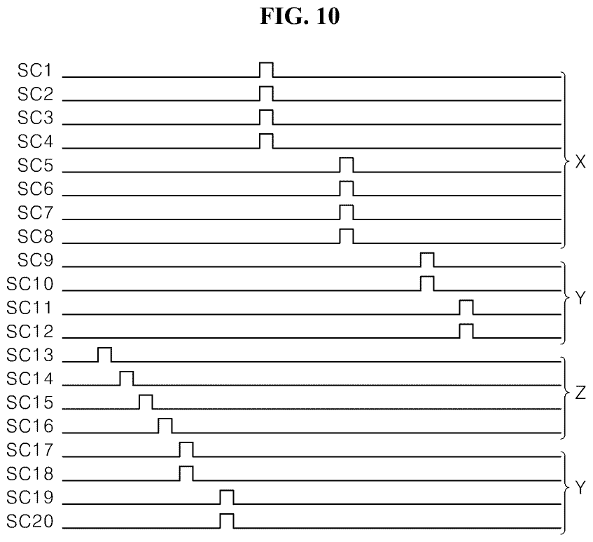

FIG. 6 to FIG. 11 is a diagram illustrating an operation method in response to a gaze point movement in a display apparatus according to an embodiment of the present disclosure. For convenience of description, an example in which first to twentieth scan lines are included in the display panel is set forth below. However, embodiments of the present disclosure are not limited thereto.

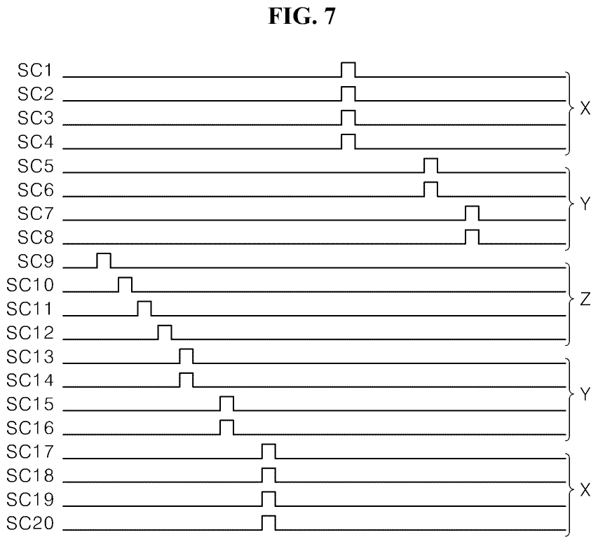

Referring to FIGS. 6 and 7, in the display apparatus 10, when the gaze focus area Z of the eye is located at the center of the display panel 100, the gate driver 300 is configured to first apply a scan signal to the gaze focus area Z of the display panel 100. For example, when the gaze focus area Z is located at the center of the screen of the display, the display apparatus selects the center thereof as a scan start point in consideration of the gaze focus position and the foveated rendering area. The display apparatus 10 may be configured to apply the sequential driving and group driving to the middle area Y and the peripheral area X other than the gaze focus area Z at a low resolution to drive the middle area Y and the peripheral area X other than the gaze focus area Z at a lower resolution.

For example, first, the gate driver 300 may be configured to sequentially apply ninth to twelfth scan signals SC9, SC10, SC11, and SC12 to the gaze focus area Z located in the center of the display panel 100 on a single scan line basis (e.g., scan lines SC9, SC10, SC11, and SC12 may be configured to be not electrically connected to each other, each scan signal may be applied to a respective scan line, and the scan signals may be applied sequentially).

Then, the gate driver 300 may be configured to sequentially apply 13th and 14th scan signals SC13 and SC14 and 15th and 16th scan signals SC15 to SC16 to the middle area Y located under the gaze focus area Z on a basis of two scan lines (e.g., two scan lines SC13 and SC14 may be configured to be electrically connected to each other and driven together simultaneously, and two scan lines SC15 to SC16 may be configured to be electrically connected to each other and driven together simultaneously).

Subsequently, the gate driver 300 may be configured to simultaneously apply 17th to 20th scan signals SC17 to SC20 to the peripheral area X located under the middle area Y on a basis of four scan lines (e.g., four scan lines SC17 to SC20 may be configured to be electrically connected to each other and driven together simultaneously).

Subsequently, the gate driver 300 may be configured to simultaneously apply first to fourth scan signals SC1 to SC4 to the peripheral area X located on top of the middle area Y on a basis of four scan lines.

Subsequently, the gate driver 300 may be configured to sequentially apply fifth and sixth scan signals SC5 and SC6 and seventh and eighth scan signals SC7 to SC8 to the middle area Y located on top of the gaze focus area Z on a basis of two scan lines.

While the gate driver 300 operates, the data driver 400 may be configured to apply a data voltage to the gaze focus area Z on a single data line basis, apply a data voltage to the middle area Y on a basis of two data lines, and apply a data voltage to the peripheral area X on a basis of four data lines.

In an example of applying data voltages to the gaze focus area Z on a single data line basis (see, e.g., the gaze focus area Z in the middle column in FIG. 6), the four data lines may be configured to be not electrically connected to each other, each data voltage may be applied to a respective data line, and the data voltages may be applied sequentially.

In an example of applying data voltages to the middle area Y on a basis of two data lines (see, e.g., the middle area Y in a column located to the right of the middle column in FIG. 6), a first set having two data lines may be configured to be electrically connected to each other, a second set having two other data lines may be configured to be electrically connected to each other, a first data voltage may be applied to the first set simultaneously, and a second data voltage may be applied to the second set simultaneously.

In an example of applying data voltages to the peripheral area X on a basis of four data lines (see, e.g., the peripheral area X in the last column in FIG. 6), the four data lines may be configured to be electrically connected to each other, and a data voltage may be applied to the four data lines simultaneously.

As described above, the display apparatus may first perform the scan driving of the gaze focus area to improve the response characteristics. In addition, the display apparatus may reduce the latency by displaying the gaze focus area in high quality and the areas other than the gaze focus area in low quality. However, this is merely an example. While the gate driver 300 operates, the data driver 400 may apply the data voltage to the gaze focus area Z, the middle area Y, and the peripheral area X on a basis of the same number of data lines (e.g., on a single data line basis).

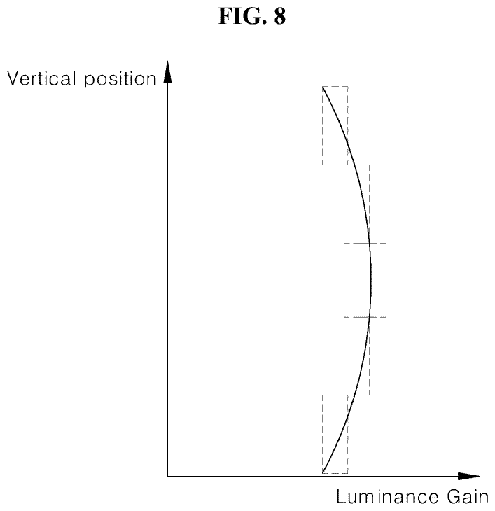

In addition, the display apparatus may control luminance of the gaze focus area Z, the middle area Y, and the peripheral area X to be different from each other. As shown in FIG. 8, in response to the gaze point of the eye of the user being located at the center of the display panel 100, the luminance gain value of the gaze focus area Z located at the center is the largest, the luminance gain value of the middle area Y is the middle value, and the luminance gain value of the peripheral area X is the smallest.

The display apparatus may calculate a luminance gain value of each of the gaze focus area Z, the middle area Y, and the peripheral area X based on the foveated rendering information received from the external system. The gamma characteristics of the display is considered to adjust the luminance. For this reason, a process of changing the gray data into the luminance data may be performed, and the luminance compensation method may be selectively applied thereto based on the foveated rendering information.

When the gaze focus area Z is located in the center of the screen of the display panel 100, the display apparatus 10 may be configured to calculate a luminance gain factor using the vertical and horizontal symmetrical Gaussian Function.

As described above, the display apparatus 10 may be configured to calculate the luminance gain values of the gaze focus area Z, the middle area Y, and the peripheral area X and control the luminance thereof based on the calculation result, thereby reducing power consumption. Thus, the use time of the display apparatus may be further extended.

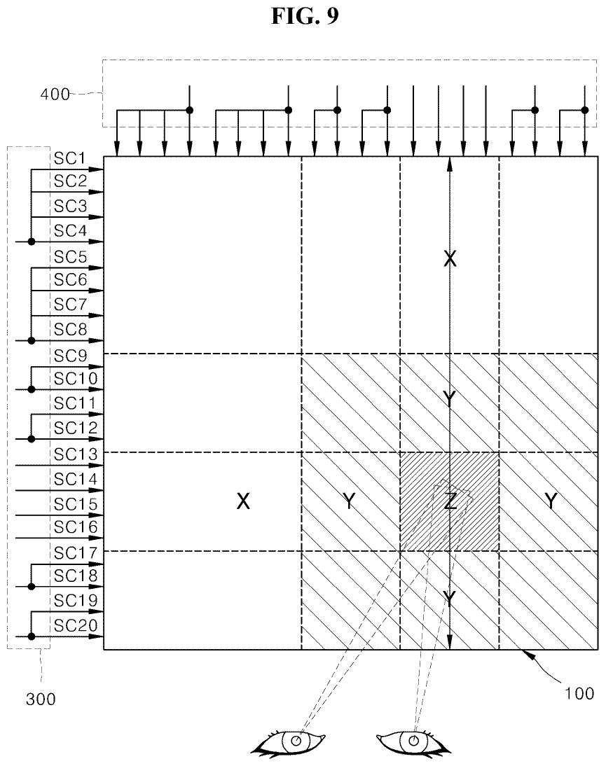

FIGS. 9 to 11 illustrate the operation of the display apparatus in response to the gaze point of the eye of the user being changed from the center point of the display panel to the lower right point thereof.

Referring to FIGS. 9 to 11, in the display apparatus, when the gaze focus area Z is changed from the center point of the display panel 100 to the lower right point thereof, the gate driver 300 may be configured to first apply a scan signal to the changed gaze focus area Z. For example, the display apparatus 10 may be configured to select the scan start point as the gaze focus area Z in consideration of the gaze focus position and the foveated rendering area and to first drive the gaze focus area Z. The display apparatus 10 may be configured to apply the sequential driving and group driving to the middle area Y and the peripheral area X other than the gaze focus area Z such that the middle area Y and the peripheral area X are displayed at a low resolution.

For example, first, the gate driver 300 may be configured to sequentially apply 13th to 16th scan signals SC13, SC14, SC15, and SC16 to the gaze focus area Z located at the lower right area of the center of the display panel 100 on a single scan line basis.

Subsequently, the gate driver 300 may be configured to sequentially apply 17th and 18th scan signals SC17 and SC18 and 19th and 20th scan signals SC19 to SC20 to the middle area Y located under the gaze focus area Z on a basis of two scan lines.

Subsequently, the gate driver 300 may be configured to sequentially apply the first to fourth scan signals SC1 to SC4 and the fifth to eighth scan signals SC5 to SC8 to the peripheral area X positioned above the middle area Y of the display panel 10 on a basis of four scan lines.

Subsequently, the gate driver 300 may be configured to sequentially apply the ninth and tenth scan signals SC9 and SC 10 and the eleventh and twelfth scan signals SC11 to SC12 to the middle area Y located under the peripheral area X on a basis of two scan lines.

While the gate driver 300 operates, the data driver 400 may be configured to apply a data voltage to the gaze focus area Z on a single data line basis, apply a data voltage to the middle area Y on a basis of two data lines, and apply a data voltage to the peripheral area X on a basis of four data lines.

As described above, in response to the gaze point of the eye of the user being changed from the center of the display panel to the lower right area, the display apparatus may first perform the scan driving of the gaze focus area on which the gaze is focused, thereby improving the response characteristics and reducing the latency.

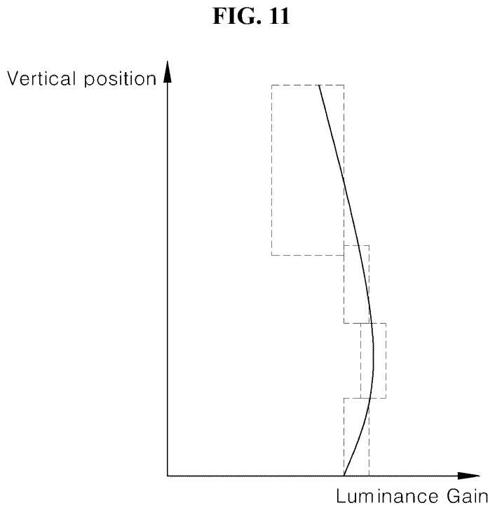

In addition, as illustrated in FIG. 11, in the display apparatus 10, when the gaze focus position of the gaze is located at the lower right area of the display panel 100, the luminance gain value of the gaze focus area Z located at the lower right area is the largest, the luminance gain value of the middle area Y is the middle value, and the luminance gain value of the peripheral area X is the smallest.

When the gaze focus area Z is located at the lower right area of the display apparatus, only a portion of the vertical and horizontal symmetrical Gaussian function is utilized to calculate the luminance gain factor.

As described above, in response to the gaze point of the eye of the user being changed from the center of the display panel to the lower right area, the display apparatus may calculate the luminance gain value of each of the changed gaze focus area Z, the middle area Y, and the peripheral area X and control the luminance of each of the changed gaze focus area Z, the middle area Y, and the peripheral area X based on the calculation result, thereby reducing power consumption. Thus, the display apparatus may be used for a time duration larger than a conventional use time duration.

In addition, the display apparatus applies dynamic foveated rendering for tracking the gaze in real time to ensure stable performance of a graphics processing device of the external system, and first drives the gaze focus area to improve response characteristics.

In addition, the display apparatus may first drive the gaze focus area of the user's eye in response to the change in the gaze to improve response characteristics without delay due to sequential driving, and may control luminance of the different areas to be different from each other, thereby reducing power consumption.

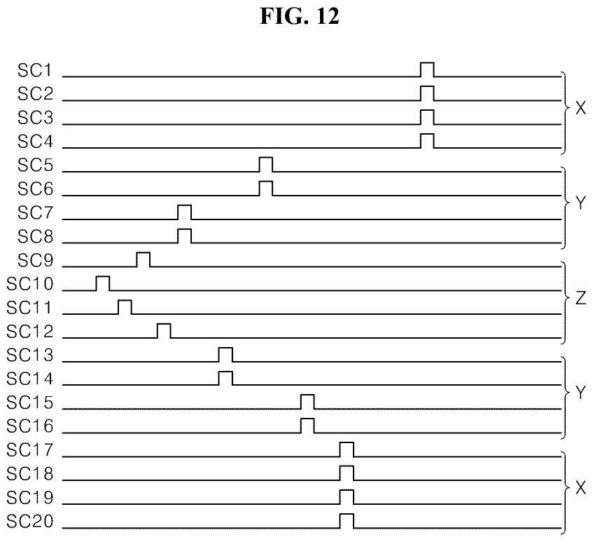

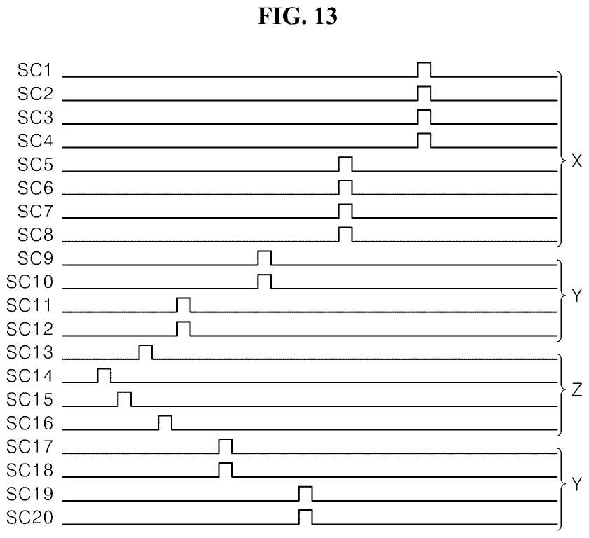

FIGS. 12 and 13 are diagrams illustrating an operation method in response to a gaze point movement in a display apparatus according to another embodiment of the present disclosure.

FIG. 12 illustrates an operation of the gate driver 300 when the gaze focus area Z as the gaze point of the eye of the user is located at the center of the display panel 100.

Referring to FIG. 12 and FIG. 6 corresponding thereto, first, the gate driver 300 may be configured to sequentially apply the scan signals to the gaze focus area Z located at the center of the display panel 100 in an alternating manner in a vertical direction.

For example, the gate driver 300 may be configured to sequentially apply the 10th, 11th, 9th, and 12th scan signals SC10, SC11, SC9, and SC12 to the gaze focus area Z located at the center of the display panel 100 on a single scan line basis in an alternating manner in a vertical direction.

Subsequently, the gate driver 300 may be configured to sequentially apply the seventh and eighth scan signals SC7 and SC8, the 13th and 14th scan signals SC13 to SC14, the fifth and sixth scan signals SC5 and SC6, and the 15th and 16th scan signals SC15 to SC16 to the middle areas Y respectively located on top of and under the gaze focus area Z on a basis of two scan lines in an alternating manner in a vertical direction.

Subsequently, the gate driver 300 may be configured to sequentially apply 17th to 20th scan signals SC17 to SC20 and the first to fourth scan signals SC1 to SC4 to the peripheral areas X respectively positioned on top of and under the respective middle area Y on a basis of four scan lines.

In addition, the display apparatus calculates the luminance gain of each of the gaze focus area Z, the middle area Y, and the peripheral area X using the vertical and horizontal symmetrical Gaussian function and controls the luminance of each of the gaze focus area Z, the middle area Y, and the peripheral area X, based on the calculation result.

As described above, the display apparatus 10 may first perform the scan driving of the gaze focus area Z, and may perform the scan driving in the alternating manner with each other in the vertical direction, thereby further improving the response characteristics and further lowering the latency.

FIG. 13 illustrates an operation of the gate driver 300 when the gaze focus area Z as the gaze point of the eye of the user is changed from the center of the display panel 100 to the lower right end.

Referring to FIG. 13 and FIG. 9 corresponding thereto, first, the gate driver 300 may be configured to sequentially apply scan signals to the gaze focus area Z located at the lower right end of the display panel 100 in the vertically alternating manner.

For example, the gate driver 300 may be configured to sequentially apply the 14th, 15th, 13th, and 16th scan signals SC14, SC15, SC13, and SC16 to the gaze focus area Z located at the lower right end of the display panel 100 on a single scan line basis in the vertically alternating manner.

Subsequently, the gate driver 300 may be configured to sequentially apply the 11th and 12th scan signals SC11 and SC12, the 17th and 18th scan signals SC17 to SC18, the ninth and 10th scan signals SC9 and SC10, the 19th and 20th scan signals SC19 to SC20 to the middle areas Y respectively located on top of and under the gaze focus area Z on a basis of two scan lines in a vertically alternating manner.

Subsequently, the gate driver 300 may be configured to sequentially apply the fifth to eighth scan signals SC5 to SC8 and the first to fourth scan signals SC1 to SC4 to the peripheral area X positioned on top of the middle area Y of the display panel 10 on a basis of four scan lines.

As described above, in response to the gaze point of the eye of the user being changed from the center to the lower right end of the display panel, the display apparatus may first perform the scan driving of the gaze focus area on which the gaze is focused, and may perform the scan driving in the vertically alternating manner, thereby improving the response characteristics of the gaze focus area, and reducing the latency.

In addition, the display apparatus may first drive the gaze focus area on which the gaze is focused immediately in response to the change in the gaze focus position of the gaze, thereby improving the response characteristics. Furthermore, the display apparatus may control luminance of the different areas to be different from each other, thereby reducing power consumption.

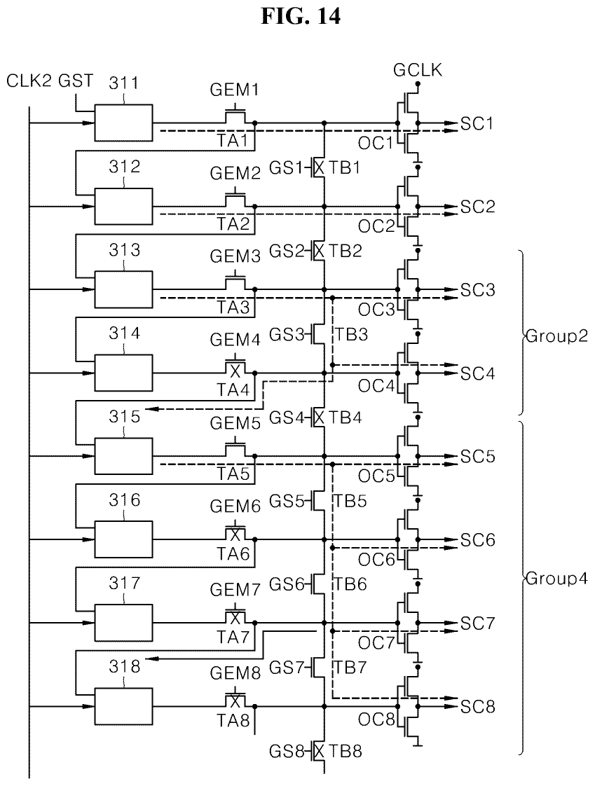

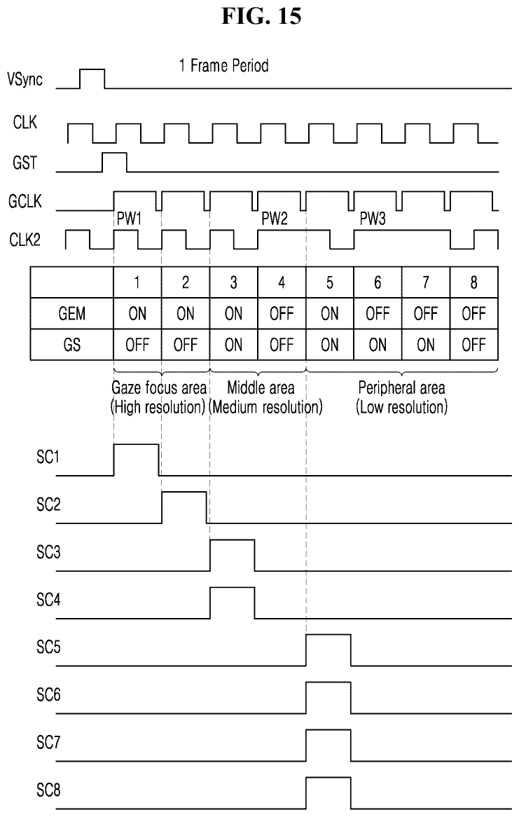

FIG. 14 is a circuit diagram illustrating a gate driver in a display apparatus according to an embodiment of the present disclosure. FIG. 15 is a diagram illustrating an operation timing of the gate driver of FIG. 14. For convenience of illustration, FIGS. 14 and 15 illustrate only a partial configuration in which the first to eighth scan signals SC1 to SC8 are output.

Referring to FIGS. 14 and 15, the gate driver 300 includes first to eighth logic circuits 311, 312, 313, 314, 315, 316, 317, and 318, first to eighth enable transistors TA1, TA2, TA3, TA4, TA5, TA6, TA7, and TA8, first to eighth connection transistors TB1, TB2, TB3, TB4, TB5, TB6, TB7, and TB8, and first to eighth output circuits OC1, OC2, OC3, OC4, OC5, OC6, OC7, and OC8.

The first to eighth logic circuits 311, 312, 313, 314, 315, 316, 317, and 318 operate in response to a carry signal or a clock signal CLK2. In this regard, the first logic circuit 311 receives a start signal GST as the carry signal, and each of the second to eighth logic circuits 312, 313, 314, 315, 316, 317, and 318 receives an output signal of a respective one of the first to seventh enable transistors TA1, TA2, TA3, TA4, TA5, TA6, and TA7 of the previous stage as the carry signal.

In this regard, a pulse width of the clock signal CLK2 applied to the first to eighth logic circuits 311, 312, 313, 314, 315, 316, 317, and 318 may vary based on the gaze focus area Z, the middle area Y, and the peripheral area X, which are defined based on a distance from the gaze point of the gaze.

For example, the clock signal CLK2 of the gaze focus area Z may toggle with the same first pulse width PW1, the clock signal CLK2 of the middle area Y may toggle with the first pulse width and then toggle with a second pulse width PW2 greater than the first pulse width, and the clock signal CLK2 of the peripheral area X may toggle with the first pulse width and then toggle with a third pulse width PW3 greater than the second pulse width.

The second pulse width PW2 allows an output of the logic circuit connected to a first scan line of the middle area Y to be maintained at an on level such that the output of the logic circuit connected to a first scan line of the middle area Y is output from the logic circuit connected to the last scan line of the middle area Y. For example, the output signal output from the third logic circuit 313 may be provided, as a carry signal, to the fourth logic circuit 314 through the third enable transistor TA3 turned on in response to a third grouping enable signal GEM3.

At the same time, the third scan signal SC3 may be output to the third scan line through the third output circuit OC3 in response to the output signal. At the same time, the output signal of the third logic circuit 313 may be provided to the fourth output circuit OC4 through the third connection transistor TB3 turned on in response to a third grouping signal GS3, and the fourth output circuit OC4 may output the fourth scan signal SC4 having the same on timing as the on timing of the third scan signal SC3. In addition, the output signal of the third logic circuit 313 may be provided to the fifth logic circuit 315 through the third connection transistor TB3 and a second node (second electrode) of the fourth enable transistor TA4. That is, the fifth logic circuit 315 may receive an output (e.g., a carry signal) of the third logic circuit 313 for a third period 3.

In a sequential scan scheme, for a period (a fourth period 4), the fourth scan signal SC4 is output. However, in this approach, the fourth scan signal SC4 is not output for the fourth period 4. In this case, each of a fourth grouping enable signal GEM4 and a fourth grouping signal GS4 may have a turn-off level. In addition, since the clock signal CLK2 is maintained at a turn-on level for the fourth period 4, the carry signal provided to the fifth logic circuit 315 may be maintained at the turn-on level.

For a fifth period 5, the fifth enable transistor TA5 and the fifth connection transistor TB5 may be turned on in response to a fifth grouping enable signal GEM5 and a fifth grouping signal GS5. Accordingly, the fifth scan signal SC5 may be output for the fifth period 5.

In other words, the turn-on level of the clock signal CLK2 may be maintained until a time point at which a first scan signal (e.g., the fifth scan signal SC5) of the peripheral area X transitions to the turn-on level so that the first scan signal (e.g., the fifth scan signal SC5) of the peripheral area X may be output. For example, the third pulse width PW3 may be greater than the first pulse width PW1 and may correspond to the number of scan lines corresponding to the peripheral area X. When four scan lines are included in the peripheral area X, the third pulse width PW3 may be four times of the first pulse width PW1.

The driving of the peripheral area X is substantially the same as the scan driving of the middle area Y except for only the number of scan lines simultaneously outputting the scan signal. Thus, a redundant description thereof will be omitted.

For example, when the peripheral area X includes 16 scan lines, the third pulse width PW3 of the clock signal CLK 2 corresponding to the peripheral area X may be 16 times of the first pulse width PW1.

The first to eighth enable transistors TA1, TA2, TA3, TA4, TA5, TA6, TA7, and TA8 may have respective first electrodes connected to respective output terminals of the first to eighth logic circuits 311, 312, 313, 314, 315, 316, 317, and 318, and may have respective second electrodes connected to respective input terminals of the second to ninth logic circuits 312, 313, 314, 315, 316, 317, 318, and 319 (not shown). In this regard, the first and second electrodes may be source and drain electrodes of the transistor. In one or more aspects, a source electrode may be referred to as a drain electrode, and vice versa. In an example, the first to eighth enable transistors TA1, TA2, TA3, TA4, TA5, TA6, TA7, and TA8 may be p-type metal oxide semiconductor field effect transistors (MOSFETs), where the first and second electrodes may be source and drain electrodes of the respective transistor. In another example, the first to eighth enable transistors TA1, TA2, TA3, TA4, TA5, TA6, TA7, and TA8 may be n-type MOSFETS, where the first and second electrodes may be drain and source electrodes of the respective transistor.

The first to eighth enable transistors TA1, TA2, TA3, TA4, TA5, TA6, TA7, and TA8 operate in response to the first to eighth grouping enable signals GEM1, GEM2, GEM3, GEM4, GEM5, GEM6, GEM7, and GEM8, respectively. The first to eighth grouping enable signals GEM1, GEM2, GEM3, GEM4, GEM5, GEM6, GEM7, and GEM8 may be included in the gate control signal GCS provided from the controller 200 and provided to the gate driver 300.

The first to eighth enable transistors TA1, TA2, TA3, TA4, TA5, TA6, TA7, and TA8 may be configured to transmit respective output signals of the first to eighth logic circuits 311, 312, 313, 314, 315, 316, 317, and 318 to the first to eighth output circuits OC1, OC2, OC3, OC4, OC5, OC6, OC7, and OC8, respectively.

In addition, the first to eighth enable transistors TA1, TA2, TA3, TA4, TA5, TA6, TA7, and TA8 may be configured to transmit the respective output signals of the first to eighth logic circuits 311, 312, 313, 314, 315, 316, 317, and 318 to the second to ninth logic circuits 312, 313, 314, 315, 316, 317, 318, and 319 (not shown), respectively.

Each of the first to eighth connection transistors TB1, TB2, TB3, TB4, TB5, TB6, TB7, and TB8 is connected to and disposed between the second electrodes of the respective first to eighth enable transistors TA1, TA2, TA3, TA4, TA5, TA6, TA7, and TA8. For example, the first connection transistor TB1 is connected to and disposed between the second electrodes of the first and second enable transistors TA1 and TA2. The second connection transistor TB2 is connected to and disposed between the second electrodes of the second and third enable transistors TA2 and TA3.

The first to eighth connection transistors TB1, TB2, TB3, TB4, TB5, TB6, TB7, and TB8 operate in response to the first to eighth grouping signals GS1, GS2, GS3, GS4, GS5, GS6, GS7, and GS8, respectively. The first to eighth grouping signals GS1, GS2, GS3, GS4, GS5, GS6, GS7, and GS8 may be included in the gate control signal GCS provided from the controller 200 and provided to the gate driver 300.

The first to eighth connection transistors TB1, TB2, TB3, TB4, TB5, TB6, TB7, and TB8 may be used to selectively group the scan signals by selectively connecting the respective outputs of the first to eighth enable transistors TA1, TA2, TA3, TA4, TA5, TA6, TA7, and TA8.

The first to eighth output circuits OC1, OC2, OC3, OC4, OC5, OC6, OC7, and OC8 are connected to the second electrodes of the first to eighth enable transistors TA1, TA2, TA3, TA4, TA5, TA6, TA7, and TA8, respectively, and are configured to perform pull-up or pull-down to output the first to eighth scan signals. Each of the first to eighth output circuits OC1, OC2, OC3, OC4, OC5, OC6, OC7, and OC8 may include a pull-up transistor and a pull-down transistor that respectively perform pull-up and pull-down in response to the output signal of the respective one of the first to eighth enable transistors TA1, TA2, TA3, TA4, TA5, TA6, TA7, and TA8. A global clock GCLK may be applied to a source electrode of the pull-up transistor. A drain electrode thereof may be connected to an output terminal from which the scan signal is output. A drain electrode of the pull-down transistor may be connected to the output terminal from which the scan signal is output, while the gate low voltage may be applied to a source electrode of the pull-down transistor. In this example, the pull-up transistor may be a p-type MOSFET, and the pull-down transistor may be an n-type MOSFET; however, the subject technology is not limited thereto.

Referring to FIGS. 14 and 15, some operations of the gate driver 300 are illustrated based on one frame period according to the vertical synchronization signal Vsync.

The gate driver 300 may be configured to sequentially apply the first and second scan signals SC1 and SC2 to the gaze focus area Z of the display panel 100 on a single scan line basis. In this regard, the first and second enable transistors TA1 and TA2 operating in response to the respective first and second grouping enable signals GEM1 and GEM2 are turned on (ON), and the first and second connection transistors TB1 and TB2 operating in response to the respective first and second grouping signals GS1 and GS2 are turned off (OFF).

The gate driver 300 is configured to group the third and fourth scan signals SC3 and SC4 into a group (i.e., Group2) and apply the third and fourth scan signals SC3 and SC4 to the middle area Y on a basis of two scan lines. In this regard, among the third and fourth enable transistors TA3 and TA4 operating in response to the respective third and fourth grouping enable signals GEM3 and GEM4, the third enable transistor TA3 is turned on, and the fourth enable transistor TA4 is turned off. Among the third and fourth connection transistors TB3 and TB4 operating in response to the respective third and fourth grouping signals GS3 and GS4, the third connection transistor TB3 is turned on, and the fourth connection transistor TB4 is turned off.

The gate driver 300 is configured to group the fifth to eighth scan signals SC5, SC6, SC7, and SC8 into a group (i.e., Group4) and apply the fifth to eighth scan signals SC5, SC6, SC7, and SC8 to the peripheral area X on a basis of four scan lines. In this regard, among the fifth to eighth enable transistors TA5, TA6, TA7, and TA8 operating in response to the respective fifth to eighth grouping enable signals GEM5, GEM6, GEM7, and GEM8, the fifth enable transistor TA5 is turned on, and the sixth to eighth enable transistors TA6, TA7, and TA8 are turned off. The fifth to eighth connection transistors TB5, TB6, TB7 and TB8 operating in response to the respective fifth to eighth grouping enable signals GS5, GS6, GS7, and GS8, the fifth to seventh connection transistors TB5, TB6 and TB7 are turned on, and the eighth connection transistor TB8 is turned off.

As described above, the display apparatus may drive the gaze focus area Z, the middle area Y, and the peripheral area X at the high resolution, the medium resolution, and the low resolution, respectively, thereby reducing the latency. In addition, the display apparatus can reduce the latency, thereby securing stable performance of the graphics processing device of the external system in applying the foveated rendering technology.

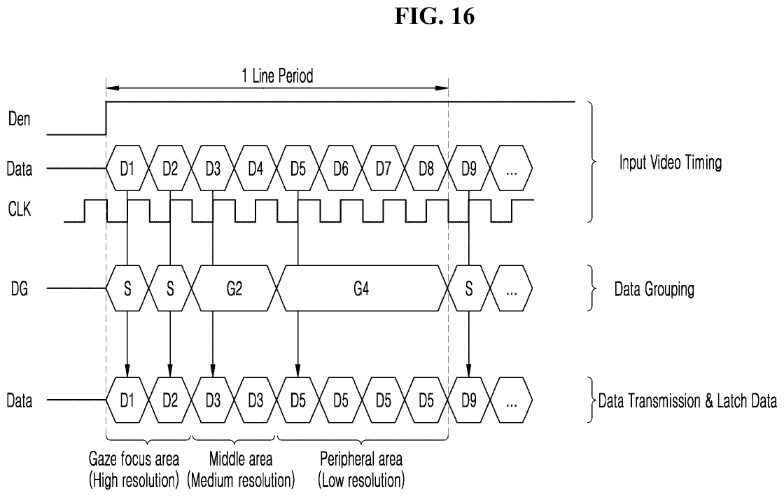

FIG. 16 is a diagram illustrating data processing based on a gaze point of an eye of a user in a display apparatus according to an embodiment of the present disclosure. FIG. 16 illustrates an operation of one horizontal line period.

Referring to FIG. 16, the controller 200 sequentially receives image data D1, D2, D3, D4, D5, D6, D7, D8, and D9 in accordance with a video timing clock CLK input from an external system.

The controller 200 is configured to define an area of the display panel into a gaze focus area, a middle area, and a peripheral area, based on gaze focus position information. In this regard, the input image is displayed in the gaze focus area at a high resolution, in the middle area at a medium resolution, and in the peripheral area at a low resolution.

The controller 200 is configured to generate a data grouping (DG) signal corresponding to each of the gaze focus area, the middle area, and the peripheral area and align the image data based on the DG signal and transmit the aligned image data to the source driver D-IC of the data driver 400.

For example, the controller 200 may be configured to transmit the image data of the gaze focus area to be driven at a high resolution to the source driver D-IC in a non-modified manner. The controller 200 may be configured to group the image data of the middle area to be driven at a medium resolution on a basis of two lines, process the image data, and transmit the processed image data to the source driver D-IC. The controller 200 may be configured to group the image data of the peripheral area to be driven at a low resolution on a basis of four lines, and process the image data, and transmit the processed image data to the source driver D-IC.

In one example, when the image data D3 and D4 of two lines are grouped into a group, the controller 200 may process the image data D3 and D4 as one image data D3. In addition, when the image data D5, D6, D7, and D8 of four lines are grouped into a group, the controller 200 may process the image data D5, D6, D7, and D8 as one image data D5.

The image data on which the image processing has been completed may be sequentially transmitted to the source driver D-IC, latched in the source driver D-IC, and simultaneously transmitted to the display panel for each horizontal line.

The aforementioned terms “two lines” and “four lines” in reference to FIG. 16 may refer to “two data lines” and “four data lines,” respectively.

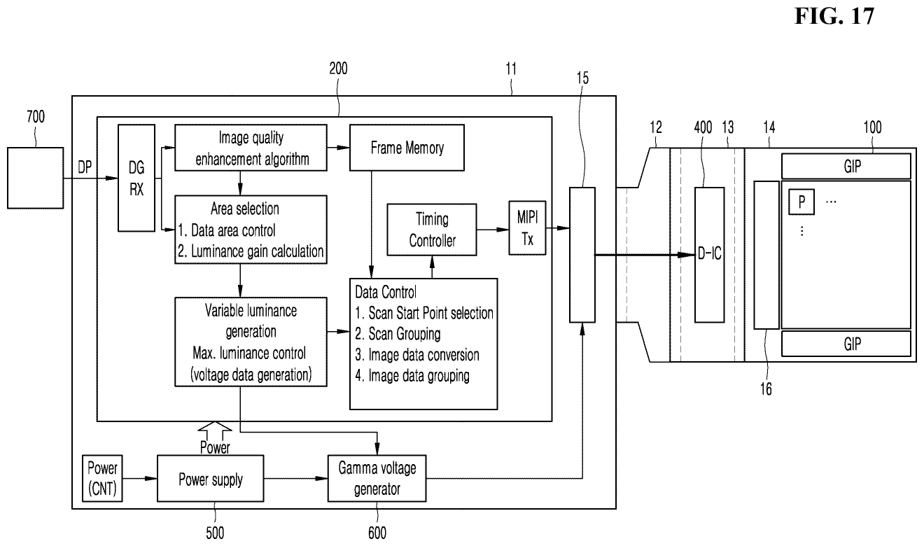

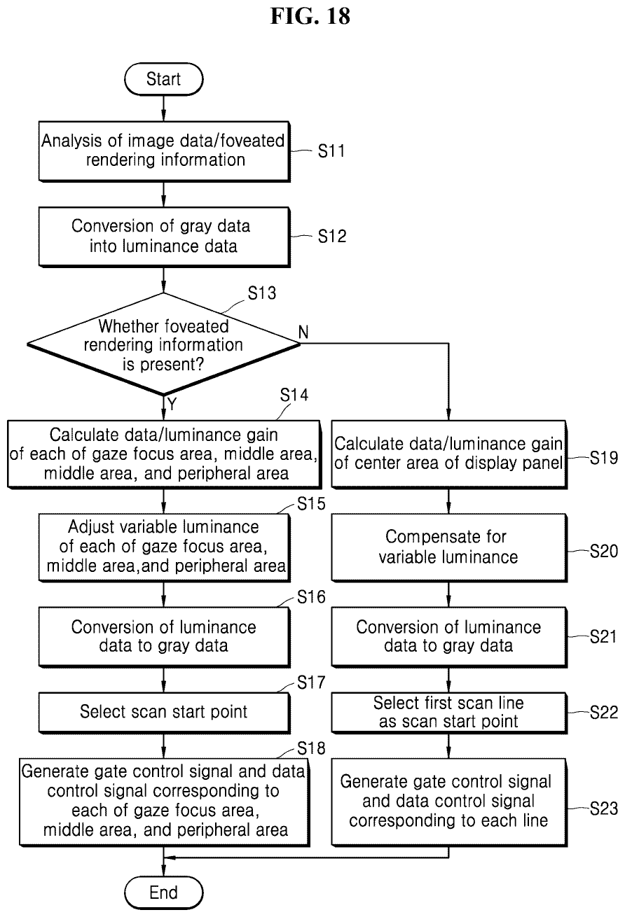

FIG. 17 is a block diagram illustrating a controller of a display apparatus according to an embodiment of the present disclosure. FIG. 18 is a flowchart illustrating a method for controlling a display apparatus according to an embodiment.

Referring to FIGS. 17 and 18, the controller 200 analyzes the image data and the foveated rendering information received from a graphics processing device 700 of the external system in S11. The external system may generate the gaze focus position information of the user's eye using sensing information received from one or more sensors, and may provide the gaze focus position information to the display apparatus.

In an aspect, a sensor for producing sensing information may be any device configured to detect eye position, movement, or gaze direction. In some examples, the sensor may include an image-based device such as an infrared or visible light camera, optionally used with an illumination source. In other examples, the sensor may comprise an electrooculography (EOG) sensor with electrodes proximate to the eye, a scleral contact lens sensor with embedded elements, or a magnetic or inertial sensor for tracking orientation. In one or more examples, the sensor may include any optical, electromagnetic, or biosignal-based device capable of determining eye gaze.

The controller 200 converts the gray data of the image data into luminance data in S12, and determines whether the foveated rendering information is present in S13. Upon determination that the foveated rendering information is present, the controller 200 sets resolutions of the gaze focus area, the middle area, and the peripheral area defined based on the foveated rendering information to be different from each other. The controller 200 calculates luminance gains of the gaze focus area, the middle area, and the peripheral area in S14.

The controller 200 compensates for variable luminance of each of the gaze focus area, the middle area, and the peripheral area in S15, and converts luminance data into gray data in S16. The controller 200 selects a scan start point based on the gaze point of the eye of the user in S17, and generates a gate control signal and a data control signal corresponding to each of the gaze focus area, the middle area, and the peripheral area in S18.

Upon determination that there is no foveated rendering information, the controller 200 calculates data and a luminance gain based on a central area of the display panel in S19, compensates for variable luminance in S20, and converts luminance data into gray data in S21.

The controller 200 selects a first scan line as a scan start line in S22 and generates a gate control signal and a data control signal corresponding to each scan line in S23.

The controller 200 generates information about a gaze focus area, a middle area, and a peripheral area based on a display resolution. Further, because gamma characteristics of the display is considered to adjust luminance, the controller 200 changes the gray data into the luminance data, and selectively applies a luminance compensation method based on the foveated rendering information.

When the luminance compensation has been completed, the controller 200 converts the compensated luminance data into the gray data again, defines the scan driving start point based on the foveated rendering information, and changes an output timing of the image data according to the scan driving start point and outputs the image data at the changed output timing.

In the scan driving scheme, the scan driving start point may be selected in consideration of a user's gaze point and the foveated rendering information, and the scan lines may be driven in a sequential manner N+1, N+2, etc. and/or in a vertically alternating manner N+1, N−1, N+2, and N−2, etc., where N may be a whole number.

A luminance compensation checking method will be described as follows. The luminance compensation may be checked via the voltage data transmission process between a gamma voltage generator 600 and the controller 200, and based on presence or absence of a change in an output level of the gamma voltage generator 600. Alternatively, the luminance compensation may be checked based on the luminance change of the gaze tracking information area in the virtual reality (VR) environment. Alternatively, the luminance compensation may be checked based on the maximum luminance in the central area of the display panel and the luminance change in the gaze tracking information area.

In one example, the controller 200, the power supply 500, the gamma voltage generator 600, and connector 15 may be mounted on a control board 11. Lines for electrically connecting the controller 200 and the source driver D-IC of the data driver 400 to each other may be mounted on a source board 12. The source driver D-IC of the data driver 400 may be mounted on a film 13. The display panel 100, the GIP, and the demultiplexer and the ADC 16 may be mounted on a panel 14.

In one or more examples, a controller may include one or more processors configured to execute instructions. The controller may further include memory for storing instructions and data, interfaces for communicating with other components, and circuitry for generating control signals based on received data. A processor may include a microprocessor, a microcontroller, and/or a digital signal processor.

In one or more aspects, foveated rendering information may refer to data and/or parameters used by a graphics processing device to control rendering quality based on a user's gaze. In an example, the foveated rendering information may specify one or more areas of an image, including a gaze focus area, a middle area, and a peripheral area. In one or more examples, the foveated rendering information may include the resolution, level of detail, shading rate, texture resolution, other rendering characteristics for each area, and/or transition functions that may govern the gradual change in rendering quality from the gaze focus area to the peripheral area.

In one or more examples, the foveated rendering information may include dynamic parameters that adjust rendering behavior in response to real-time gaze data, user-specific calibration, and/or predicted eye movements. In one or more examples, it may also include control metadata for directing the timing, sequence, and/or grouping of scan-line updates for different areas, in order to improve rendering efficiency and reducing processing load on the graphics processing device. In one or more examples, the foveated rendering information may enable a graphics system to render high-detail images where the user is looking, while reducing detail in the middle and peripheral areas to optimize computational resources without perceptible loss of visual quality.

In an aspect, an element may include a plurality of elements unless the context clearly indicates otherwise. For instance, a gate control signal may include a plurality of gate control signals, and a data control signal may include a plurality of data control signals unless the context expressly indicates otherwise. For instances, a scan signal may include a plurality of scan signals, and a data voltage my include a plurality of data voltages unless the context clearly indicates otherwise.

The term “scan start point” may be sometimes referred to as “scan driving start point” and vice versa.

A “subset” of elements (e.g., a subset of scan signals, or a subset of data voltages) may include one element among the elements, or may include multiple elements among the elements. For example, if the elements include a first element, a second element, and a third element, then a subset of the elements may include one, some or all of the first element, the second element, and the third element. The terms “first subset of the elements,” “second subset of the elements,” “third subset of the elements,” and the like (e.g., a first subset of the scan signals, a second subset of the scan signals, a third subset of the scan signals, a first subset of the data voltages, a second subset of the data voltages, and a third subset of the data voltages) are intended to identify a subset from another subset, and these are not used to define the essence, basis, order, or number of the subsets or elements. In an example, a first subset may denote a second subset, and, similarly, a second subset may denote a first subset. For clarity, the functions or structures of these subsets (e.g., the first subset, the second subset, and the like) are not limited by ordinal numbers or the names in front of the subsets.

Various examples and aspects of the present disclosure are described below. These are provided as examples, and do not limit the scope of the present disclosure.

One or more aspects of the present disclosure provide a display apparatus comprising: a display panel configured to display an image; a data driver configured to supply data voltages to the display panel; a gate driver configured to supply scan signals to the display panel; and a controller configured to: select a gaze focus area as a scan driving start point, based on a focus position of a gaze and foveated rendering information, wherein the gaze focus area is an area on which the gaze of a user is being focused; and control the gate driver to first supply a first subset of the scan signals to the gaze focus area as the scan driving start point.

In one or more examples, the controller is further configured to: divide a region of the display panel into the gaze focus area, a middle area, and a peripheral area, based on a distance from the focus position of the gaze; and control the data driver and the gate driver to drive the gaze focus area at a full resolution, the middle area at a medium resolution, and the peripheral area at a low resolution, wherein the full resolution is higher than the medium resolution, and the medium resolution is higher than the low resolution.

In one or more examples, the controller is further configured to control the gate driver to output the first subset of the scan signals to the gaze focus area on a single scan line basis, to output a second subset of the scan signals to the middle area on a basis of at least two scan lines, and to output a third subset of the scan signals to the peripheral area on a basis of at least four scan lines.

In one or more examples, the controller is further configured to control the data driver to apply a first subset of the data voltages to the gaze focus area on a single pixel basis, to apply a second subset of the data voltages to the middle area on a basis of at least two pixels, and to apply a third subset of the data voltages to the peripheral area on a basis of at least four pixels.

In one or more examples, the controller is further configured to: calculate a luminance gain value of each of the gaze focus area, the middle area, and the peripheral area; and maintain luminance of the gaze focus area, and control luminance of the middle area to be lower than the luminance of the gaze focus area, and control luminance of the peripheral area to be lower than the luminance of the middle area, based on the calculated luminance gain values.

In one or more examples, the controller is configured to adjust a gamma reference voltage of a gamma voltage generator, which is configured to supply the gamma reference voltage to the data driver, thereby controlling the luminance of each of the gaze focus area, the middle area, and the peripheral area.

In one or more examples, the gate driver includes: first to (N+1)th logic circuits configured to operate in response to a carry signal or a clock signal; first to (N+1)th enable transistors, wherein first electrodes of the first to N-th enable transistors are connected to output terminals of the first to N-th logic circuits, respectively, and second electrodes of the first to N-th enable transistors are connected to input terminals of the second to (N+1)th logic circuits, respectively; the (N+1)th enable transistor has a second electrode; first to N-th connection transistors connected to and disposed between the second electrodes of the first to (N+1)th enable transistors, respectively; and first to (N+1)th output circuits connected to the second electrodes of the first to (N+1)th enable transistors, respectively, wherein each of the first to (N+1)th output circuits is configured to perform a pull-up or pull-down operation to output a respective one of first to (N+1)th scan signals, wherein the scan signals comprise the first to (N+1)th scan signals, and wherein N is a whole number.

In one or more examples, the first to (N+1)th enable transistors are configured to operate in response to first to (N+1)th grouping enable signals, respectively, wherein the first to N-th connection transistors are configured to operate in response to first to N-th grouping signals, respectively, wherein the first to (N+1)th enable transistors are configured to be selectively enabled based on the first to (N+1)th grouping enable signals, respectively, and the first to N-th connection transistors are configured to be selectively enabled based on the first to N-th grouping signals, thereby selectively grouping the first to (N+1)th scan signals.

In one or more examples, the controller is further configured to include the first to (N+1)th grouping enable signals and the first to N-th grouping signals into gate control signals, and provide the gate control signals to the gate driver.

In one or more examples, a pulse width of the clock signal is determined in proportion to a number of scan signals grouped into one group.

In one or more examples, the controller is configured to group image data of each of the middle area and the peripheral area other than the gaze focus area, to align the grouped image data, and to transmit the aligned image data to the data driver.

In one or more examples, the controller is further configured to control the gate driver: to first supply the first subset of the scan signals to the gaze focus area in a sequential manner; and to subsequently supply a subset of the scan signals to each of the middle area and the peripheral area other than the gaze focus area in a sequential and grouped manner.

In one or more examples, the controller is further configured to control the gate driver: to first supply the first subset of the scan signals to the gaze focus area in a sequential manner and in a vertical alternating manner; and to subsequently supply, in a sequential and grouped manner and in a vertical alternating manner, a second subset of the scan signals to a middle area and a third subset of the scan signals to a peripheral area, without supplying the second subset and the third subset to the gaze focus area.

One or more aspects of the present disclosure provide a display apparatus comprising: a display panel in which a plurality of pixels are disposed in an area where each of data lines and each of scan lines intersect each other, wherein the display apparatus is configured to: select a gaze focus area as a scan driving start point on the display panel, based on a focus position of a gaze of a user; and first supply a first subset of scan signals to the gaze focus area via a first subset of the scan lines.

In one or more examples, the display apparatus is further configured to: divide a region of the display panel into the gaze focus area, a middle area, and a peripheral area based on the focus position of the gaze; and drive the gaze focus area at a full resolution, drive the middle area at a medium resolution, and drive the peripheral area at a low resolution, wherein the full resolution is higher than the medium resolution, and the medium resolution is higher than the low resolution.

In one or more examples, the display apparatus is further configured to: sequentially drive the gaze focus area on a single scan line basis; and drive each of the middle area and the peripheral area on a basis of at least two scan lines in a sequential and grouped manner.

In one or more examples, the display apparatus is further configured to: drive the gaze focus area on a single scan line basis sequentially and in a vertical alternating manner; and drive each of the middle area and the peripheral area on a basis of at least two scan lines in a sequential and grouped manner and in a vertical alternating manner.

In one or more examples, the display apparatus is further configured to: apply a subset of data voltages to the gaze focus area on a single data line basis; and apply a subset of the data voltages to each of the middle area and the peripheral area on a basis of at least two data lines in a grouped manner.

In one or more examples, the display apparatus is further configured to maintain luminance of the gaze focus area, and to control luminance of each of the middle area and the peripheral area to be lower than the luminance of the gaze focus area, based on image data.

In one or more examples, the display apparatus further comprises a gate driver configured to sequentially drive the scan lines and/or drive at least two scan lines in a grouped manner, wherein the gate driver includes: first to (N+1)th logic circuits configured to operate in response to a carry signal or a clock signal; first to (N+1)th enable transistors, wherein first electrodes of the first to N-th enable transistors are connected to output terminals of the first to N-th logic circuits, respectively, and second electrodes of the first to N-th enable transistors are connected to input terminals of the second to (N+1)th logic circuits, respectively; the (N+1)th enable transistor has a second electrode; first to N-th connection transistors connected to and disposed between the second electrodes of the first to (N+1)th enable transistors, respectively; and first to (N+1)th output circuits connected to the second electrodes of the first to (N+1)th enable transistors, respectively, wherein each of the first to (N+1)th output circuits is configured to perform a pull-up or pull-down operation to output a respective one of first to (N+1)th scan signals, wherein the scan signals comprise the first to (N+1)th scan signals, and wherein N is a whole number.

One or more aspects of the present disclosure provide a display apparatus comprising: a plurality of pixels; data lines; and scan lines, wherein the data lines and the scan lines intersect each other, and wherein the display apparatus is configured to: select a gaze focus area on a display panel, based on a focus position of a gaze; and first apply a first subset of data voltages to the gaze focus area via a first subset of the data lines.

In one or more examples, the display apparatus further comprises a data driver, wherein the data driver is configured to first apply the first subset of the data voltages to the gaze focus area on a single data line basis, and subsequently apply a second subset of the data voltages to a middle area on a basis of first multiple data lines and a third subset of data voltages to a peripheral area on a basis of a second multiple data lines.

In one or more examples, a number of the first multiple data lines is different from a number of the second multiple data lines.

In one or more examples, the first multiple data lines include two data lines, and the second multiple data lines include four data lines.

In one or more examples, the data driver is configured to first apply the first subset of the data voltages to the gaze focus area in a sequential manner; and to subsequently apply a subset of the data voltages to each of a middle area and a peripheral area other than the gaze focus area in a sequential and grouped manner.

In one or more examples, the data driver is configured to first apply the first subset of the data voltages to the gaze focus area in a sequential manner and in a horizontal alternating manner; and to subsequently apply, in a sequential and grouped manner and in a horizontal alternating manner, a second subset of the data voltages to a middle area and a third subset of the data voltages to a peripheral area, without applying the second and third subset of the data voltages to the gaze focus area.

In one or more examples, the data driver is configured to sequentially apply the first subset of the data voltages to the gaze focus area on a single scan line basis; and apply a subset of the data voltages to each of the middle area and the peripheral area on a basis of at least two data lines in a sequential and grouped manner.

The description herein has been presented to enable any person skilled in the art to make, use and practice the technical features of the present disclosure, and has been provided in the context of one or more particular example applications and their example requirements. Although some embodiments of the present disclosure have been described above with reference to the accompanying drawings, the present disclosure may not be limited to some embodiments and may be implemented in various different forms. Those of ordinary skill in the technical field to which the present disclosure belongs will be able to appreciate that the present disclosure may be implemented in other specific forms without changing the technical idea or essential features of the present disclosure. Therefore, it should be understood that some embodiments as described above are not restrictive but illustrative in all respects. Thus, the scope of the present disclosure is not limited to the embodiments shown, but is to be accorded the widest scope consistent with the claims and their equivalents.

What is claimed is:

1. A display apparatus, comprising:
a display panel configured to display an image;
a data driver configured to supply data voltages to the display panel;
a gate driver configured to supply scan signals to the display panel; and
a controller configured to:
select a gaze focus area as a scan driving start point, based on a focus position of a gaze and foveated rendering information, wherein the gaze focus area is an area on which the gaze of a user is being focused; and
control the gate driver to first supply a first subset of the scan signals to the gaze focus area as the scan driving start point.

2. The display apparatus of claim 1, wherein the controller is further configured to:
divide a region of the display panel into the gaze focus area, a middle area, and a peripheral area, based on a distance from the focus position of the gaze; and
control the data driver and the gate driver to drive the gaze focus area at a full resolution, the middle area at a medium resolution, and the peripheral area at a low resolution, and
wherein the full resolution is higher than the medium resolution, and the medium resolution is higher than the low resolution.

3. The display apparatus of claim 2, wherein the controller is further configured to control the gate driver to output the first subset of the scan signals to the gaze focus area on a single scan line basis, to output a second subset of the scan signals to the middle area on a basis of at least two scan lines, and to output a third subset of the scan signals to the peripheral area on a basis of at least four scan lines.

4. The display apparatus of claim 3, wherein the controller is further configured to control the data driver to apply a first subset of the data voltages to the gaze focus area on a single pixel basis, to apply a second subset of the data voltages to the middle area on a basis of at least two pixels, and to apply a third subset of the data voltages to the peripheral area on a basis of at least four pixels.

5. The display apparatus of claim 2, wherein the controller is further configured to:
calculate a luminance gain value of each of the gaze focus area, the middle area, and the peripheral area; and
maintain luminance of the gaze focus area, and control luminance of the middle area to be lower than the luminance of the gaze focus area, and control luminance of the peripheral area to be lower than the luminance of the middle area, based on the calculated luminance gain values.

6. The display apparatus of claim 5, wherein the controller is configured to adjust a gamma reference voltage of a gamma voltage generator, which is configured to supply the gamma reference voltage to the data driver, thereby controlling the luminance of each of the gaze focus area, the middle area, and the peripheral area.

7. The display apparatus of claim 1, wherein the gate driver includes:
first to (N+1)th logic circuits configured to operate in response to a carry signal or a clock signal;
first to (N+1)th enable transistors, wherein first electrodes of the first to N-th enable transistors are connected to output terminals of the first to N-th logic circuits, respectively, and second electrodes of the first to N-th enable transistors are connected to input terminals of the second to (N+1)th logic circuits, respectively;
the (N+1)th enable transistor has a second electrode;
first to N-th connection transistors connected to and disposed between the second electrodes of the first to (N+1)th enable transistors, respectively; and
first to (N+1)th output circuits connected to the second electrodes of the first to (N+1)th enable transistors, respectively, wherein each of the first to (N+1)th output circuits is configured to perform a pull-up or pull-down operation to output a respective one of first to (N+1)th scan signals,
wherein the scan signals comprise the first to (N+1)th scan signals, and
wherein N is a whole number.

8. The display apparatus of claim 7, wherein the first to (N+1)th enable transistors are configured to operate in response to first to (N+1)th grouping enable signals, respectively,
wherein the first to N-th connection transistors are configured to operate in response to first to N-th grouping signals, respectively, and
wherein the first to (N+1)th enable transistors are configured to be selectively enabled based on the first to (N+1)th grouping enable signals, respectively, and the first to N-th connection transistors are configured to be selectively enabled based on the first to N-th grouping signals, thereby selectively grouping the first to (N+1)th scan signals.

9. The display apparatus of claim 8, wherein the controller is further configured to include the first to (N+1)th grouping enable signals and the first to N-th grouping signals into gate control signals, and provide the gate control signals to the gate driver.

10. The display apparatus of claim 7, wherein a pulse width of the clock signal is determined in proportion to a number of scan signals grouped into one group.

11. The display apparatus of claim 1, wherein the controller is configured to group image data of each of a middle area and a peripheral area other than the gaze focus area, to align the grouped image data, and to transmit the aligned image data to the data driver.

12. The display apparatus of claim 1, wherein the controller is further configured to control the gate driver:
to first supply the first subset of the scan signals to the gaze focus area in a sequential manner; and
to subsequently supply a subset of the scan signals to each of a middle area and a peripheral area other than the gaze focus area in a sequential and grouped manner.

13. The display apparatus of claim 1, wherein the controller is further configured to control the gate driver:
to first supply the first subset of the scan signals to the gaze focus area in a sequential manner and in a vertical alternating manner; and
to subsequently supply, in a sequential and grouped manner and in a vertical alternating manner, a second subset of the scan signals to a middle area and a third subset of the scan signals to a peripheral area, without supplying the second subset and the third subset to the gaze focus area.

14. A display apparatus, comprising:
a display panel in which a plurality of pixels are disposed in an area where each of data lines and each of scan lines intersect each other,
wherein the display apparatus is configured to:
select a gaze focus area as a scan driving start point on the display panel, based on a focus position of a gaze of a user; and
first supply a first subset of scan signals to the gaze focus area via a first subset of the scan lines.

15. The display apparatus of claim 14, wherein the display apparatus is further configured to:
divide a region of the display panel into the gaze focus area, a middle area, and a peripheral area based on the focus position of the gaze; and
drive the gaze focus area at a full resolution, drive the middle area at a medium resolution, and drive the peripheral area at a low resolution, and
wherein the full resolution is higher than the medium resolution, and the medium resolution is higher than the low resolution.

16. The display apparatus of claim 15, wherein the display apparatus is further configured to:
sequentially drive the gaze focus area on a single scan line basis; and
drive each of the middle area and the peripheral area on a basis of at least two scan lines in a sequential and grouped manner.

17. The display apparatus of claim 15, wherein the display apparatus is further configured to:
drive the gaze focus area on a single scan line basis sequentially and in a vertical alternating manner; and
drive each of the middle area and the peripheral area on a basis of at least two scan lines in a sequential and grouped manner and in a vertical alternating manner.

18. The display apparatus of claim 15, wherein the display apparatus is further configured to:
apply a subset of data voltages to the gaze focus area on a single data line basis; and
apply a subset of the data voltages to each of the middle area and the peripheral area on a basis of at least two data lines in a grouped manner.

19. The display apparatus of claim 15, wherein the display apparatus is further configured to maintain luminance of the gaze focus area, and to control luminance of each of the middle area and the peripheral area to be lower than the luminance of the gaze focus area, based on image data.

20. The display apparatus of claim 14, wherein the display apparatus further comprises a gate driver for sequentially driving the scan lines, for driving at least two scan lines in a grouped manner, or for sequentially driving the scan lines and driving at least two scan lines in a grouped manner,
wherein the gate driver includes:
first to (N+1)th logic circuits configured to operate in response to a carry signal or a clock signal;
first to (N+1)th enable transistors, wherein first electrodes of the first to N-th enable transistors are connected to output terminals of the first to N-th logic circuits, respectively, and second electrodes of the first to N-th enable transistors are connected to input terminals of the second to (N+1)th logic circuits, respectively;
the (N+1)th enable transistor has a second electrode;
first to N-th connection transistors connected to and disposed between the second electrodes of the first to (N+1)th enable transistors, respectively; and
first to (N+1)th output circuits connected to the second electrodes of the first to (N+1)th enable transistors, respectively, wherein each of the first to (N+1)th output circuits is configured to perform a pull-up or pull-down operation to output a respective one of first to (N+1)th scan signals,
wherein the scan signals comprise the first to (N+1)th scan signals, and
wherein N is a whole number.
